(19) United States
(12) Patent Application Publication
(10) Pub. No.: US 2006/0028492 A1
(43) Pub. Date: Feb. 9, 2006

(54) Information processing apparatus and video data luminance control method

(76) Inventors: Tatsuo Yamaguchi, Ome-shi (JP); Eiki Obara, Hiki-gun (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/116,793

(22) Filed: Apr. 28, 2005

(30) Foreign Application Priority Data
Aug. 5, 2004 (JP) 2004-229521

(51) Int. Cl. G09G 5/10

(52) U.S. Cl. 345/690

(57) ABSTRACT

An information processing apparatus capable of displaying video data on a display panel includes a unit which calculates for each pixel the difference value between the luminance of the current frame of the video data and that of the preceding frame, a selection unit which executes for each pixel a process of selecting a compensation amount having a smaller value among the first compensation amount obtained by applying the calculated difference value to the first luminance compensation characteristic in which the compensation amount increases in accordance with an increase in difference value and the second compensation amount obtained by applying the calculated difference value to the second luminance compensation characteristic in which the compensation amount decreases in accordance with the increase in difference value, and a luminance change unit which changes for each pixel the luminance of the current frame by using the compensation amount selected by the selection unit.

### CROSS-REFERENCE TO RELATED APPLICATIONS

This application is based upon and claims the benefit of priority from the prior Japanese Patent Application No. 2004-229521, filed Aug. 5, 2004, the entire contents of which are incorporated herein by reference.

### BACKGROUND OF THE INVENTION

1. Field of the Invention

The present invention relates to an information processing apparatus such as a personal computer and a video data luminance control method used in the apparatus.

2. Description of the Related Art

Recently, personal computers having an AV (Audio Video) function equivalent to an AV device such as a DVD (Digital Versatile Disc) player or TV set have been developed.

Most of such personal computers comprise a liquid crystal display panel (LCD) as their display monitor. In general, it is difficult to display a fast-moving scene at high image quality because the response speed in the middle gradation region of the LCD is relatively low.

Japanese Patent Application KOKAI No. 2003-29713 discloses an LCD overdrive process in order to improve the LCD response time in the middle gradation region. The LCD overdrive process is a technique of shortening a time necessary to change a given luminance value of a pixel on a display to a target luminance value by controlling a driving voltage applied to the LCD. This technique can improve the LCD response time in the middle gradation region. The LCD overdrive process is generally implemented using a method called level-adaptive overdrive (LAO). Level-adaptive overdrive (LAO) uses a look-up table in order to obtain at a high speed the gain of an

optimal driving voltage necessary to improve the LCD response time in the middle gradation region.

A conventional LCD overdrive process is implemented using hardware logic dedicated to drive the LCD. When the LCD overdrive function is implemented in a personal computer, the number of components increases, raising the cost of the personal computer.

The look-up table is also implemented by hardware. Thus, the use of the look-up table is not suitable when the personal computer executes the LCD overdrive process by software. Implementation of the look-up table function by software greatly increases the arithmetic amount.

### BRIEF SUMMARY OF THE INVENTION

It is an object of the present invention to provide an information processing apparatus and luminance control method capable of improving the response time of a display panel at a small arithmetic amount.

According to an embodiment of the present invention, there is provided an information processing apparatus capable of displaying video data on a display panel, comprising means for calculating for each pixel a difference value between a luminance of a current frame of the video data and a luminance of an immediately preceding frame, selection means for executing for each pixel a process of selecting a compensation amount having a smaller value among a first compensation amount obtained by applying the calculated difference value to a first luminance compensation characteristic in which a compensation amount increases in accordance with an increase in the difference value and a second compensation amount obtained by applying the calculated difference value to a second luminance compensation characteristic in which the compensation amount decreases in accordance with the increase in the difference value, and luminance change means for changing for each pixel the luminance of the current frame by using the compensation amount selected by the selection means.

In an embodiment, a luminance control device for controlling a luminance of video data displayed on a display panel comprises a difference value between a luminance of a current frame of the video data and a luminance of a preceding frame for a pixel, and a luminance compensation value based on a first compensation amount and a second compensation amount, where the first compensation amount increases in accordance with an increase in the difference value and where the second compensation amount decreases in accordance with the increase in the difference value.

In another embodiment, an information processing apparatus capable of displaying video data on a display panel comprises means for calculating for a pixel a difference value between a luminance of a current frame of the video data and a luminance of a preceding frame, and means for determining a luminance compensation value based on a first compensation amount and a second compensation amount, where the first compensation amount increases in accordance with an increase in the difference value and where the second compensation amount decreases in accordance with the increase in the difference value.

In yet another embodiment, a luminance control method of controlling a luminance of video data displayed on a display panel comprises calculating for a pixel a difference value between a luminance of a current frame of the video data and a luminance of a preceding frame, and determining a luminance compensation value based on a first compensation amount and a second compensation amount, where the first compensation amount increases in accordance with an increase in the difference value and where the second compensation amount decreases in accordance with the increase in the difference value.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing the outer appearance of a notebook type personal computer according to an embodiment of the present invention;

FIG. 2 is a block diagram showing the system configuration of the computer in FIG. 1;

FIG. 3 is a block diagram showing the functional configuration of a TV application program used in the computer in FIG. 1;

FIG. 4 is a graph for explaining the first and second luminance compensation characteristics used in the computer in FIG. 1;

FIG. 5 is a flowchart showing the sequence of a digital overdrive process executed by the computer in FIG. 1; and

FIG. 6 is a view for explaining how to execute the digital overdrive process for successive frames in the computer in FIG. 1.

### DETAILED DESCRIPTION OF THE INVENTION

A preferred embodiment of the present invention will be described below with reference to the several views of the accompanying drawing.

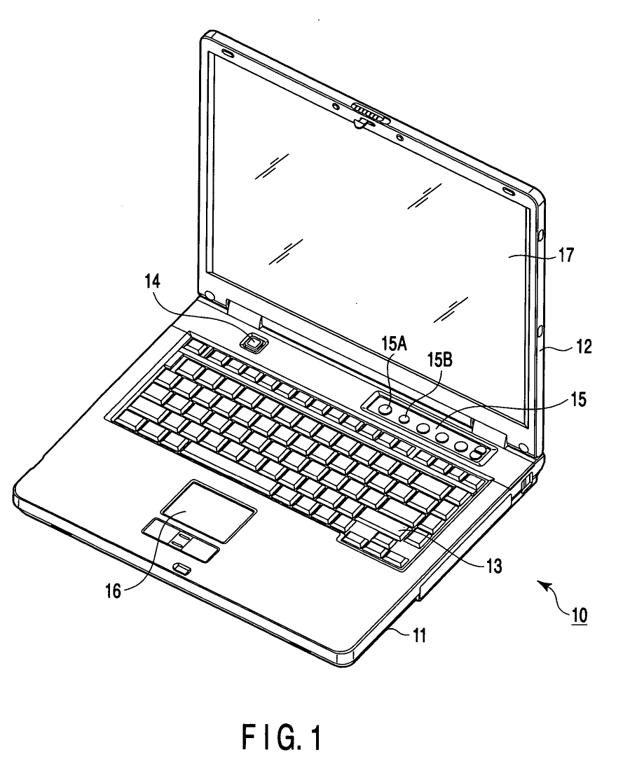

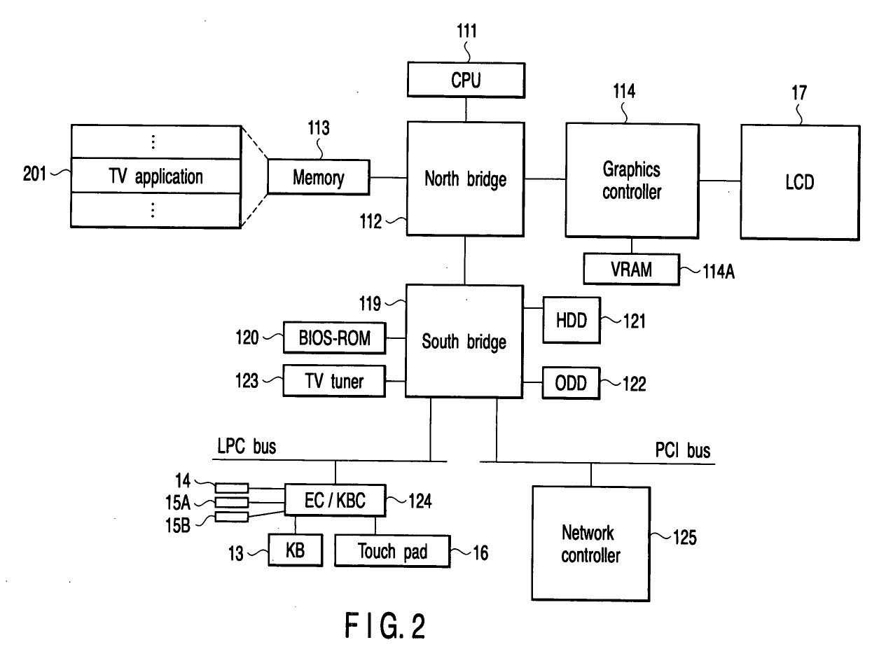

The configuration of an information processing apparatus according to the embodiment of the present invention will be explained with reference to FIGS. 1 and 2. The information processing apparatus is implemented as, e.g., a notebook type portable personal computer 10.

FIG. 1 is a perspective view when the display unit of the notebook type portable personal computer 10 is open. The computer 10 comprises a computer main body 11 and display unit 12. The display unit 12 incorporates a display device formed from a TFT-LCD (Thin Film Transistor Liquid Crystal Display) 17, and the display screen of the LCD 17 is located at almost the center of the display unit 12.

The display unit 12 is attached to the computer main body 11 to freely pivot between open and closed positions. The computer main body 11 has a thin box-like housing, and its upper surface is equipped with a keyboard 13, a power button 14 for turning on/off the computer 10, an input operation panel 15, a touch pad 16, and the like.

The input operation panel 15 is an input device for inputting an event corresponding to a pressed button, and comprises a plurality of buttons for activating a plurality of functions. These buttons include a TV start button 15A and DVD/CD start button 15B. The TV start button 15A activates a TV function of playing back and recording TV broadcast program data. When the TV start button 15A is pressed by the user, a TV application program for executing the TV function is automatically activated.

A sub-operating system dedicated to process AV (Audio Video) data is installed in the computer in addition to a general-purpose main operating system. The TV application program runs on the sub-operating system.

When the power button 14 is pressed by the user, the main operating system is activated. When the TV start button 15A is pressed by the user, not the main operating system but the sub-operating system is activated, and the TV application program is automatically executed. The sub-operating system has only minimum functions for executing the AV function. Hence, a time necessary to boot up the sub-operating system is much shorter than a time necessary to boot up the main operating system. The user can quickly watch/record the TV by simply pressing the TV start button 15A.

The DVD/CD start button 15B is a button for playing back video contents recorded on a DVD or CD. When the DVD/CD start button 15B is pressed by the user, a video playback application program for playing back video contents is automatically activated. The video playback application program also runs on the sub-operating system. When the DVD/CD start button 15B is pressed by the user, not the main operating system but the sub-operating system is activated, and the video playback application program is automatically executed.

The system configuration of the computer 10 will be explained with reference to FIG. 2.

As shown in FIG. 2, the computer 10 incorporates-a CPU 111, north bridge 112, main memory 113, graphics controller 114, south bridge 119, BIOS-ROM 120, hard disk drive (HDD) 121, optical disk drive (ODD) 122, TV tuner 123, embedded controller/keyboard controller IC (EC/KBC) 124, network controller 125, and the like.

The CPU 111 is a processor adopted to control the operation of the computer 10. The CPU 111 executes the main operating system/sub-operating system and various application programs such as a TV application program 201 which are loaded from the hard disk drive (HDD) 121 to the main memory 113.

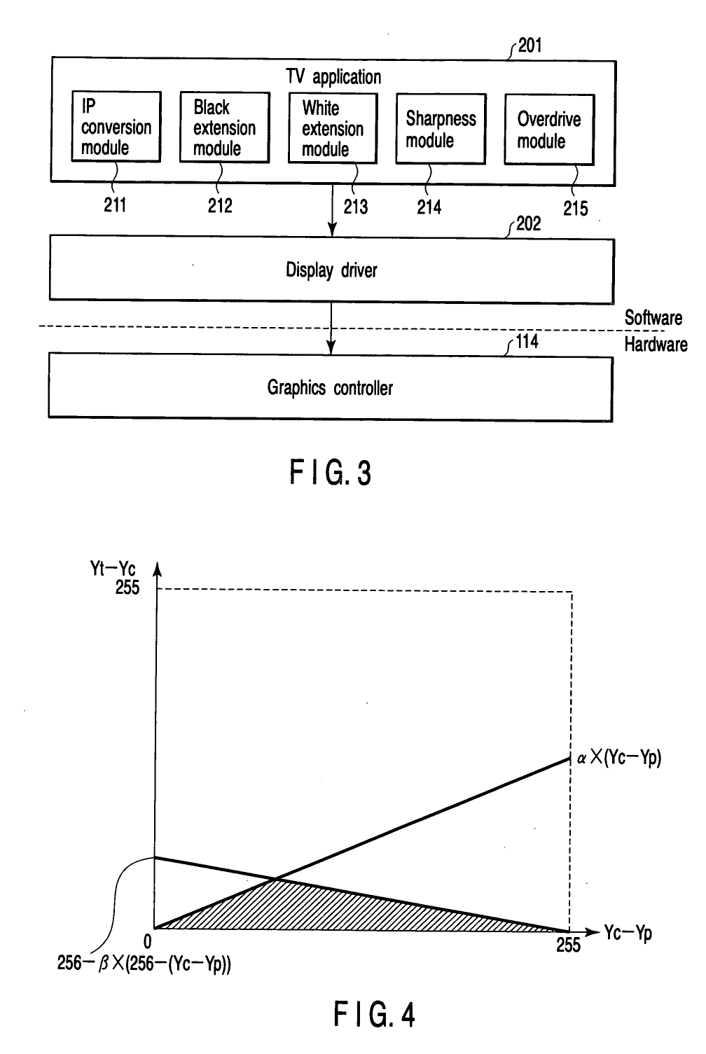

The TV application program 201 has a function of converting video data contained in TV broadcast program data received by the TV tuner 123 into high-quality data. More specifically, as shown in FIG. 3, the TV application program 201 serving as a video process function of converting video data into high-quality data comprises an IP conversion module 211, black extension module 212, white extension module 213, sharpness module 214, and overdrive module 215. The IP conversion module 211 executes a progressive conversion process of converting video data from an interlaced image into a progressive image having a double data amount. In the progressive conversion process, motion detection is executed on a pixel by pixel basis for the pixels of a video frame. The black extension module 212 and white extension module 213 execute processes of extending and correcting the black and white gradation levels. The sharpness module 214 executes a sharpness process such as edge enhancement. The overdrive module 215 executes a digital overdrive process for improving the LCD response time by changing the luminance value of the video data. Thus, the LCD response time can be improved without a hardware logic dedicated to drive the LCD, such as a look-up table and without increasing the amount of arithmetic. The digital overdrive process executes a process of changing the luminance value of the current frame on the basis of the difference between the luminance of the current frame and that of the preceding frame, e.g., immediately preceding frame. These modules 211 to 215 can display video data such as a TV broadcast program on the LCD 17 at high quality.

The high-quality video data converted by the TV application program 201 is written in a video memory 114A of the graphics controller 114 via a display driver 202. The display driver 202 is software for controlling the graphics controller 114.

The CPU 111 also executes a system BIOS (Basic Input Output System) stored in the BIOS-ROM 120. The system BIOS is a program for controlling hardware.

The north bridge 112 is a bridge device which connects the local bus of the CPU 111 and the south bridge 119. The north bridge 112 also incorporates a memory controller which controls access to the main memory 113. The north bridge 112 also has a function of executing communication with the graphics controller 114 via an AGP (Accelerated Graphics Port) bus or the like.

The graphics controller 114 is a display controller which controls the LCD 17 used as the display monitor of the computer 10. The graphics controller 114 generates a display signal to be sent to the LCD 17 from high-quality data written in the video memory (VRAM) 114A.

The south bridge 119 controls devices on an LPC (Low Pin Count) bus and devices on a PCI (Peripheral Component Interconnect) bus. The south bridge 119 incorporates an IDE (Integrated Drive Electronics) controller for controlling the HDD 121 and ODD 122. The south bridge 119 also has a function of controlling the TV tuner 123 and a function of controlling access to the BIOS-ROM 120.

The HDD 121 is a storage device which stores various software programs and data. The optical disk drive (ODD) 122 is a drive unit for driving a storage medium such as a DVD or CD which stores video contents. The TV tuner 123 is a receiver for externally receiving broadcast program data such as a TV broadcast program data.

The embedded controller/keyboard controller IC (EC/KBC) 124 is a 1-chip microcomputer obtained by integrating an embedded controller for managing power and a keyboard controller for controlling the keyboard (KB) 13 and touch pad 16. The embedded controller/keyboard controller IC (EC/KBC) 124 has a function of powering on/off the computer 10 in accordance with user operation to the power button 14. Further, the embedded controller/keyboard controller IC (EC/KBC) 124 can power on the computer 10 in accordance with user operation to the TV start button 15A and DVD/CD start button 15B. The network controller 125 is a communication device which executes communication with an external network such as the Internet.

A digital overdrive process executed by the computer 10 will be explained.

As described above, the digital overdrive process is executed by software. The digital overdrive process can improve the LCD response time without using any hardware logic dedicated to control the LCD driving voltage.

FIG. 4 shows the two, first and second luminance compensation characteristics used in the digital overdrive process. The first and second luminance compensation characteristics are used to convert the value of the difference (Yc−Yp) into the compensation amount (Yt−Yc). The overdrive module 215 changes the luminance of each pixel of video data by selectively using the first and second luminance compensation characteristics based on the difference (Yc−Yp) between the luminance value Yc of a given pixel within the current frame and the luminance value Yp of the same pixel within the immediately preceding frame in order to improve the response time of the LCD 17 in the middle gradation region.

The first luminance compensation characteristic is given by
Yt−Yc=α×(Yc−Yp) (1)

Yc is the luminance value of a given pixel within the current frame, Yp is the luminance value of the same pixel within the immediately preceding frame, Yt is the target luminance value to which the pixel is to be changed, α is the constant, and Yt−Yc is the compensation amount necessary to change Yc to the target luminance value Yt.

The first luminance compensation characteristic exhibits a linear characteristic in which the value of the compensation amount (Yt−Yc) linearly increases at a predetermined ratio in accordance with an increase in the value of the difference (Yc−Yp) between the luminance value Yc of a given pixel within the current frame and the luminance value Yp of the same pixel within the immediately preceding frame.

FIG. 4 assumes a case in which the luminance value ranges from 0 to 255 expressible by 8-bit data.

In the use of the first luminance compensation characteristic, the value of the compensation amount (Yt−Yc) monotonically increases in accordance with an increase in the value of the difference (Yc−Yp). For this reason, no problem occurs when the value of the difference (Yc−Yp) is relatively small. However, overcompensation in which the value of the compensation amount (Yt−Yc) exceeds a proper value may occur when the value of the difference (Yc−Yp) is relatively large.

If overcompensation occurs, the luminance of an image displayed on the LCD 17 temporarily greatly changes, degrading the image quality. When the value of the difference (Yc−Yp) is relatively large, the response time of the LCD 17 is relatively short. Thus, when the value of the difference (Yc−Yp) is relatively large, the luminance value hardly need be compensated.

In order to suppress overcompensation, the embodiment adopts the second luminance compensation characteristic in addition to the above-described first luminance compensation characteristic.

The second luminance compensation characteristic is given by
Yt−Yc=256−β×(256−(Yc−Yp)) (2)
β is the constant.

The second luminance compensation characteristic exhibits a linear characteristic in which the value of the compensation amount (Yt−Yc) linearly decreases at a predetermined ratio in accordance with an increase in the value of the difference (Yc−Yp) between the luminance value Yc of a pixel within the current frame and the luminance value Yp of the same pixel within the immediately preceding frame.

In the use of the second luminance compensation characteristic, the value of the compensation amount (Yt−Yc) monotonically decreases in accordance with an increase in the value of the difference (Yc−Yp). When the value of the difference (Yc−Yp) is almost 0, the luminance value of a pixel displayed on the LCD 17 need not be changed. The second luminance compensation characteristic can suppress overcompensation in which the value of the compensation amount (Yt−Yc) exceeds a proper value when the value of the difference (Yc−Yp) is relatively large.

In the embodiment, the hatched region in FIG. 4 is used as a characteristic for converting the value of the difference (Yc−Yp) into the value of the compensation amount (Yt−Yc). For example, when α is ½ and 62 is ⅛, the value of the difference (Yc−Yp) corresponding to the intersection between a straight line given by equation (1) and a straight line given by equation (2) is 64. The overdrive module 215 uses a compensation amount obtained by applying the value of the current difference (Yc−Yp) to the first luminance compensation characteristic (equation (1)) when the value of the current difference (Yc−Yp) is smaller than 64, and a compensation amount obtained by applying the value of the current difference (Yc−Yp) to the second luminance compensation characteristic (equation (2)) when the value of the current difference (Yc−Yp) is equal to or larger than 64. As described above, α and β determine the overdrive characteristic so that α and β may be determined based on what graduation range of luminance value is corrected and the amount of correction. The values of α and β are not limited to the above real numbers.

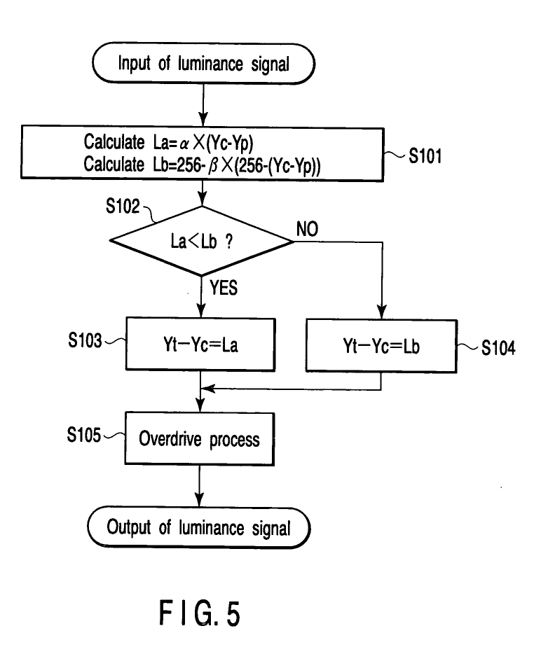

A detailed sequence of the digital overdrive process executed by the overdrive module 215 will be explained with reference to the flowchart of FIG. 5.

Frames of video data received by the TV tuner 123 are sequentially stored in the memory 113. The overdrive module 215 executes the following process for each frame of the video data stored in the memory 113.

In step S101, the overdrive module 215 calculate the luminance of the current frame of video data and that of the immediately preceding frame, and calculates for each pixel the value of the difference (Yc−Yp) between the luminance of the current frame and that of the immediately preceding frame. The overdrive module 215 applies the calculated value of the difference (Yc−Yp) to the first luminance compensation characteristic, calculating a first compensation amount La for each pixel.
La=α×(Yc−Yp)

The overdrive module 215 applies the calculated value of the difference (Yc−Yp) to the second luminance compensation characteristic, calculating a second compensation amount Lb for each pixel.
Lb=256−β×(256−(Yc−Yp))

In step S102, the overdrive module 215 compares the first compensation amount La and second compensation amount Lb for each pixel, and determines whether the first compensation amount La is smaller than the second compensation amount Lb.

If the first compensation amount La corresponding to a given pixel is smaller than the second compensation amount Lb corresponding to the pixel (YES in step S102), the overdrive module 215 selects the first compensation amount La as a compensation amount to be actually applied to the pixel in step S103 (Yt−Yc=La).

If the first compensation amount La corresponding to a given pixel is equal to or larger than the second compensation amount Lb corresponding to the pixel (NO in step S102), the overdrive module 215 selects the second compensation amount Lb as a compensation amount to be actually applied to the pixel in step S104 (Yt−Yc=Lb).

In step S105, the overdrive module 215 executes a luminance change process (overdrive process) of changing the luminance of the current frame for each pixel by using the selected La or Lb. In the luminance change process, the following process is done for each pixel. When the current luminance value Yc is larger than the luminance value Yp of the immediately preceding frame, the overdrive module 215 adds the value of the selected La or Lb to the value of the current luminance value Yc. As a result, the current luminance value Yc is changed to the target luminance value Yt, i.e., Yc+La or Yc+Lb. When the current luminance value Yc is smaller than the luminance value Yp of the immediately preceding frame, the overdrive module 215 subtracts the value of the selected La or Lb from the value of the current luminance value Yc. Consequently, the current luminance value Yc is changed to Yc−La or Yc−Lb.

In this way, the digital overdrive process of changing the luminance of each frame for each pixel is executed. Video data processed by the overdrive module 215 is written in the VRAM 114A via the display driver 202.

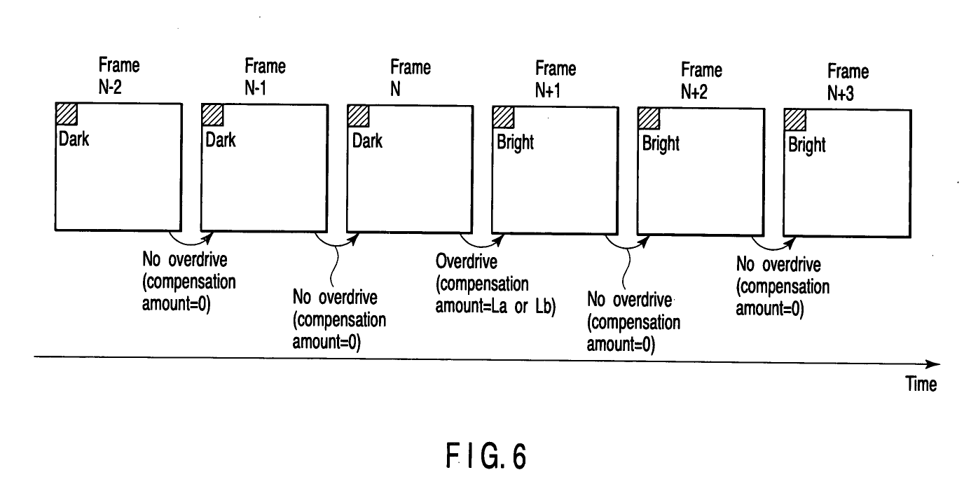

How to actually perform the overdrive process will be explained with reference to FIG. 6.

For descriptive convenience, attention is given to one pixel within a frame.

Video data such as TV broadcast data are transferred from the TV tuner 123 to the memory 113 sequentially from frame N−2, frame N−1, frame N, frame N+1, frame N+2, frame N+3, . . . . Assume that the luminance value of a given pixel changes from dark level to bright level upon switching from frame N to the next frame N+1.

During the period from frame N−2 to frame N, the luminance value of the pixel does not change. In this case, the value of the difference (Yc−Yp) is 0, and the compensation amount=0. Hence, no overdrive process is executed. Upon switching from frame N to frame N+1, the luminance of the pixel changes. The overdrive process of changing the value of the luminance Yc of the current pixel is executed in accordance with the difference (Yt−Yc) between the luminance Yc of the current pixel in frame N+1 and the luminance Yp of the pixel in frame N. The compensation amount applied in the overdrive process is the above-described first compensation amount La or Lb. In frame N+1, the luminance value of the pixel that is sent to the LCD 17 changes from Yc to Yc+La or Yc+Lb.

During the period from frame N+1 to frame N+3, the luminance value of the pixel does not change. During the period from frame N+1 to frame N+3, no overdrive process is executed, and the luminance value of the pixel that is sent to the LCD 17 is kept at Yc.

In this fashion, the overdrive process is not performed when the pixel maintains a luminance value to a certain extent, and is executed only when the luminance value of the pixel changes.

As described above, according to the embodiment, the value of the current luminance Yc is changed using a compensation amount having a smaller value among the compensation amount La obtained by applying the value of the current difference (Yc−Yp) to the first luminance compensation characteristic (equation (1)) and the compensation amount Lb obtained by applying the value of the current difference (Yc−Yp) to the second luminance compensation characteristic (equation (2)). The LCD response time in the middle gradation region can, therefore, be improved at a small arithmetic amount without causing overcompensation.

The sequence of the above-described digital overdrive process is implemented by a computer program. The same effects as those of the embodiment can be easily implemented by only installing the computer program into a general computer via a computer-readable storage medium.

The above-described digital overdrive process can also be applied to video data read out from a DVD drive.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A luminance control device for controlling a luminance of video data displayed on a display panel, comprising:
a difference value between a luminance of a current frame of the video data and a luminance of a preceding frame for a pixel; and
a luminance compensation value based on a first compensation amount and a second compensation amount, wherein the first compensation amount increases in accordance with an increase in the difference value and wherein the second compensation amount decreases in accordance with the increase in the difference value.

2. The device of claim 1 further comprising a selected compensation amount, wherein the selected compensation amount is the smaller of the first and second compensation amounts.

3. The device of claim 2 further comprising an updated luminance of the pixel of the current frame, wherein the updated luminance comprises the sum of the selected compensation amount and the luminance of the current frame when the luminance of the current frame is larger than the luminance of the preceding frame.

4. The device of claim 2 further comprising an updated luminance of the pixel of the current frame, wherein the updated luminance comprises the luminance of the current frame minus the selected compensation amount when the luminance of the current frame is smaller than the luminance value of the preceding frame.

5. The device of claim 1 wherein the display panel comprises a liquid crystal display panel.

6. The device of claim 1 further comprising:
video data of the current frame whose luminance is changed for each pixel, wherein the video data is written in a video memory; and
a display controller which generates a display signal to be sent to the display panel from the video data of the current frame that is written in the video memory.

7. The device of claim 1 further comprising a receiver that receives broadcast data, wherein the video data comprises broadcast data received by the receiver.

8. The device of claim 1 wherein the first compensation amount is given by a first equation representing a first linear characteristic in which the first compensation amount increases at a first ratio in accordance with the increase in the difference value, and wherein the second compensation amount is given by a second equation representing a second linear characteristic in which the second compensation amount decreases at a second ratio in accordance with the increase in the difference value.

9. An information processing apparatus capable of displaying video data on a display panel, comprising:
means for calculating for a pixel a difference value between a luminance of a current frame of the video data and a luminance of a preceding frame; and
means for determining a luminance compensation value based on a first compensation amount and a second compensation amount, wherein the first compensation amount increases in accordance with an increase in the difference value and wherein the second compensation amount decreases in accordance with the increase in the difference value.

10. The apparatus of claim 9 further comprising means for selecting the smaller of the first and second compensation amounts to provide a selected compensation amount.

11. The apparatus of claim 10 further comprising luminance change means for changing for the pixel the luminance of the current frame using the selected compensation amount.

12. The apparatus of claim 11 wherein the luminance change means adds the selected compensation amount when the luminance of the current frame is larger than the luminance of the preceding frame and subtracts the selected compensation amount when the luminance value of the current frame is smaller than the luminance value of the preceding frame.

13. A luminance control method of controlling a luminance of video data displayed on a display panel, comprising:
calculating for a pixel a difference value between a luminance of a current frame of the video data and a luminance of a preceding frame; and
determining a luminance compensation value based on a first compensation amount and a second compensation amount, wherein the first compensation amount increases in accordance with an increase in the difference value and wherein the second compensation amount decreases in accordance with the increase in the difference value.

14. The method of claim 13 further comprising selecting the smaller of the first and second compensation amounts.

15. The method of claim 14 further comprising changing the luminance of the pixel of the current frame by using the selected compensation amount.

16. The method of claim 15 wherein using the selected compensation amount comprises adding the selected compensation amount when the luminance of the current frame is larger than the luminance of the preceding frame.

17. The method of claim 15 wherein using the selected compensation amount comprises subtracting the selected compensation amount when the luminance value of the current frame is smaller than the luminance value of the immediately preceding frame.

18. The method of claim 13 wherein the method is implemented as computer readable program code.

19. The method of claim 13 further comprising:
writing, in a video memory, video data of the current frame whose luminance is changed for each pixel; and
generating a display signal to be sent to the display panel from the video data of the current frame that is written in the video memory.

20. The method of claim 13 wherein the first compensation amount is given by an equation representing a linear characteristic in which the first compensation amount increases at a predetermined ratio in accordance with the increase in the difference value, and wherein the second compensation amount is given by an equation representing a linear characteristic in which the second compensation amount decreases at a predetermined ratio in accordance with the increase in the difference value.
